(19) United States
(12) Patent Application Publication
(10) Pub. No.: US 2026/0121920 A1
(43) Pub. Date: Apr. 30, 2026

(54) SYSTEM AND METHOD FOR RECONFIGURATION AUTHORIZATION PROTOCOL AND ANALYTICS VIA INTEGRATED MACHINE LEARNING

(71) Applicant: BANK OF AMERICA CORPORATION, Charlotte, NC (US)

(72) Inventors: Amer Ali, Jersey City, NJ (US); Mohammad Saleem Gaziani, Plano, TX (US); Aaron Gee, Palm Coast, FL (US); Aisha Jenkins, Atlanta, GA (US); John Lozes, Wilmington, DE (US); Tonya Kyra Miller, Charlotte, NC (US); Manonmani Palanichamy, Fort Mill, SC (US); Naresh Kumar Petapalle, Welling (GB); Aravind Singtalur, McKinney, TX (US); Asha Thekkumpurath, Frisco, TX (US); Andrea M. Weisberger, Jacksonville, FL (US)

(73) Assignee: BANK OF AMERICA CORPORATION, Charlotte, NC (US)

(21) Appl. No.: 18/930,505

(22) Filed: Oct. 29, 2024

(51) Int. Cl. H04L 41/0816; H04L 41/16

(52) U.S. Cl. CPC H04L 41/0816; H04L 41/16

(57) ABSTRACT

Systems, computer program products, and methods are described herein for reconfiguration authorization protocol and analytics via integrated machine learning. The present disclosure includes receiving a proposed alteration comprising alteration data comprising an application identifier and description data, retrieving at least one configuration item device associated with the application identifier, determining a category of impact based on the alteration data, routing the alteration data to at least one module of a machine learning model, determining dependencies of the proposed alteration based on the application identifier and alteration data, determining a materiality of the proposed alteration, and causing to be displayed, at a first endpoint device, an escalation notice, upon a first condition where the materiality score is above a predetermined threshold.

### TECHNOLOGICAL FIELD

Example implementations of the present disclosure relate to a system and method for reconfiguration authorization protocol and analytics via integrated machine learning.

### BACKGROUND

Change management in production environments plays a critical role in maintaining system integrity and ensuring operational continuity. Any modification to an existing system, whether a minor tweak or a major overhaul, can introduce new impacts that could disrupt operations if not properly assessed and managed. To mitigate these impacts, entities often deploy structured frameworks that assess the potential impact of a proposed change. A common approach involves using questionnaires designed to evaluate various factors, such as the scope of the change, the number of systems affected, and the nature of the potential impacts. These assessments are typically carried out by change management and impact teams, with the goal of systematically identifying impacts prior to authorizing the change. However, such frameworks lead to errors and inconsistencies in the change management process and oftentimes significant impacts are overlooked before production environments are altered. As such, there is a need for a system and method for reconfiguration authorization protocol and analytics via integrated machine learning.

### BRIEF SUMMARY

Systems, methods, and computer program products are provided for reconfiguration authorization protocol and analytics via integrated machine learning.

In one aspect, a system for reconfiguration authorization protocol and analytics via integrated machine learning is presented. The system may include a processing device, and a non-transitory storage device containing instructions, when executed by the processing device, the instructions cause the processing device to perform the steps of: receiving a proposed alteration including alteration data including an application identifier and description data, retrieving, from a database, at least one configuration item device associated with the application identifier, determining a category of impact based on the alteration data, routing, based on the category of impact, the alteration data to at least one module of a machine learning model, wherein the at least one module may be specific to the category of impact, determining, using the at least one module of the machine learning model, dependencies of the proposed alteration based on the application identifier and alteration data, determining, using the machine learning model, a materiality of the proposed alteration, wherein the materiality comprises a materiality score, and causing to be displayed, at a first endpoint device, an escalation notice, upon a first condition where the materiality score may be above a predetermined threshold.

In some implementations, the instructions may further cause the processing device to perform the steps of: routing the proposed alteration to the first endpoint device upon the first condition where the materiality score may be above the predetermined threshold, and routing the proposed alteration to a second endpoint device upon a second condition where the materiality score may be below the predetermined threshold.

In some implementations, the instructions further cause the processing device to perform the steps of: causing to be displayed, at the first endpoint device, a query for an exception identifier, upon the first condition where the materiality score may be above the predetermined threshold.

In some implementations, the machine learning model may be trained using a system of records.

In some implementations, the machine learning model may be trained via online machine learning in conjunction with a stream of impact data from a third-party impact database.

In some implementations, the proposed alteration may be prioritized in a queue based on the materiality score.

In some implementations, the instructions may further cause the processing device to perform the steps of: determining, based on the dependencies of the proposed alteration, a presence of a mismatch between the alteration data and the dependencies of the proposed alteration, and modifying the alteration data with the dependencies of the proposed alteration, upon a third condition where the mismatch may be present.

In another aspect, a computer program product for reconfiguration authorization protocol and analytics via integrated machine learning is presented. The computer program product may include a non-transitory computer-readable medium having code causing an apparatus to: receive a proposed alteration including alteration data including an application identifier and description data, retrieve, from a database, at least one configuration item device associated with the application identifier, determine a category of impact based on the alteration data, route, based on the category of impact, the alteration data to at least one module of a machine learning model, wherein the at least one module may be specific to the category of impact, determine, using the at least one module of the machine learning model, dependencies of the proposed alteration based on the application identifier and alteration data, determine, using the machine learning model, a materiality of the proposed alteration, wherein the materiality comprises a materiality score, and cause to be displayed, at a first endpoint device, an escalation notice, upon a first condition where the materiality score may be above a predetermined threshold.

In some implementations, the code may further cause the apparatus to route the proposed alteration to the first endpoint device upon the first condition where the materiality score may be above the predetermined threshold, and route the proposed alteration to a second endpoint device upon a second condition where the materiality score may be below the predetermined threshold.

In some implementations, the code may further cause the apparatus to: cause to be displayed, at the first endpoint device, a query for an exception identifier, upon the first condition where the materiality score may be above the predetermined threshold.

In some implementations, the machine learning model may be trained using a system of records.

In some implementations, the machine learning model may be trained via online machine learning in conjunction with a stream of impact data from a third-party impact database.

In some implementations, the proposed alteration may be prioritized in a queue based on the materiality score.

In some implementations, the code may further cause the apparatus to: determine, based on the dependencies of the proposed alteration, a presence of a mismatch between the alteration data and the dependencies of the proposed alteration, and modify the alteration data with the dependencies of the proposed alteration, upon a third condition where the mismatch may be present.

In yet another aspect, a method for reconfiguration authorization protocol and analytics via integrated machine learning is presented. The method may include: receiving a proposed alteration including alteration data including an application identifier and description data, retrieving, from a database, at least one configuration item device associated with the application identifier, determining a category of impact based on the alteration data, routing, based on the category of impact, the alteration data to at least one module of a machine learning model, wherein the at least one module may be specific to the category of impact, determining, using the at least one module of the machine learning model, dependencies of the proposed alteration based on the application identifier and alteration data, determining, using the machine learning model, a materiality of the proposed alteration, wherein the materiality comprises a materiality score, and causing to be displayed, at a first endpoint device, an escalation notice, upon a first condition where the materiality score may be above a predetermined threshold.

In some implementations, the method may further include: routing the proposed alteration to the first endpoint device upon the first condition where the materiality score may be above the predetermined threshold, and routing the proposed alteration to a second endpoint device upon a second condition where the materiality score may be below the predetermined threshold.

In some implementations, the method may further include: causing to be displayed, at the first endpoint device, a query for an exception identifier, upon the first condition where the materiality score may be above the predetermined threshold.

In some implementations, the machine learning model may be trained using a system of records.

In some implementations, the machine learning model may be trained via online machine learning in conjunction with a stream of impact data from a third-party impact database.

In some implementations, the proposed alteration may be prioritized in a queue based on the materiality score.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for reconfiguration authorization protocol and analytics via integrated machine learning, in accordance with an implementation of the disclosure;

FIG. 2 illustrates an exemplary machine learning model subsystem architecture, in accordance with an implementation of the disclosure; and

FIG. 3 illustrates a process flow for reconfiguration authorization protocol and analytics via integrated machine learning, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, financial institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model to perform functions as a foundation for the larger piece of software that drives the functionality of the software. The machine learning model for any given engine may be self-contained (e.g., without interaction with other engines), or the machine learning model may be shared across one or more engines. In other words, some implementations of the larger piece of software many implement multiple machine learning models to perform functions of the various engines. In other implementations, a single machine learning model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

The technical problem with current impact assessment methodologies stems from their reliance on manual processes, which are prone to human error and subjectivity. The core of these assessments often lies in a simple questionnaire format, where change managers must provide their own evaluation of the impacts involved. This approach is problematic for several reasons. First, the individuals completing the assessments may not have a comprehensive understanding of the systems affected by the change, particularly if they are only responsible for a narrow area of the larger system. As a result, their responses may lack the depth necessary to accurately identify all relevant impacts. Second, the subjective nature of the questionnaire allows for significant variability in how impacts are perceived and recorded, with answers often based on personal judgment rather than objective data. This opens the door for inconsistent impact evaluations, where similar changes might receive vastly different assessments depending on the person completing the questionnaire.

The shortcomings of current solutions are numerous and create serious impacts in the change management process. Notably, the manual, questionnaire-based assessments are highly susceptible to bias and manipulation. Change managers, aware of the additional governance, scrutiny, and bureaucratic hurdles that accompany changes deemed “high impact” or “material,” may intentionally downplay certain impacts in order to avoid triggering more extensive reviews. This practice, while not always deliberate, can skew the impact assessment process and result in high-impact changes being misclassified as low-impact. Moreover, the time-consuming nature of manual assessments creates inefficiencies, as teams must invest resources into completing these forms without necessarily improving the accuracy of the impact evaluation. The inconsistent and often subjective results from this process leave organizations exposed to potentially serious impacts, as the true scope and impact of a change may not be fully recognized and thus increase the likelihood of operational failures post-implementation.

Addressing these challenges requires the establishment of a system and method for reconfiguration authorization protocol and analytics via integrated machine learning, which provides for the implementation of a machine learning model to predict (i.e., determine) how impactful a particular proposed change (i.e., “reconfiguration” or “alteration”) would be to the devices, servers, applications, databases, etc., of an entity, and thereby allow for informed decision-making prior to implementing any such changes. This determination results in increased efficiency in across an entity as it pertains to implementing changes, which improves workflows and reduces network downtime, without relying on oftentimes inaccurate manual processes.

To do so, a proposed changed (i.e., a change to a network configuration, application, or the like, i.e., an “alteration”) may be received, via input, and subjected to the change management system described herein. The proposed alteration may include an application identifier such as an Application ID or application name of the application primarily affected by the proposed alteration, as well as a text descriptor of the alteration itself provided as an input (i.e., what is going to be changed). Data regarding configuration items (servers, devices, etc.) associated with the application identifier and/or the type of impact (i.e., type of “impact”) may be retrieved. Based on the determined type of impact, the proposed alteration may be routed to one or more modules of a machine learning model, where the modules of the machine learning model may be specific to types of impact such as compliance and operational, reputational, strategic, model, market, liquidity, credit, or the like. The machine learning model may have been trained using a system of records and/or be trained using online machine learning techniques. In doing so, a stream of impact data from an external regulator, supplier, etc., with ongoing impacts may be integrated into the machine learning model to properly account for changes in the impact landscape. Furthermore, by using the data from the proposed alteration, system dependencies (e.g., applications, devices, servers, or the like within the system network that are dependent on the application of the proposed alteration) may determined by the machine learning model based on data in the proposed alteration. The machine learning model may then determine and output a materiality score of the proposed alteration, which is a prediction of materiality of the proposed alteration (i.e., how impactful the proposed alteration is). Given the materiality score determined, it may be beneficial to prioritize proposed alterations within a queue based on the materiality score, or routed to a specific endpoint device or group of endpoint devices if the materiality score is above or below a predetermined threshold. The proposed alteration may also require an exception identifier for any further disposition of the proposed alteration (including implementation of the proposed alteration, seeking further approval, or the like) if the materiality score is above or below a predetermined threshold, and may cause an endpoint device to display a query to receive such exception identifier. Similarly, the proposed alteration may require an escalation to a user or endpoint device(s) associated with a higher-level authority, and as such, if the materiality score is above or below a predetermined threshold, the system may cause an endpoint device to display a notice that escalation is required.

What is more, the present disclosure provides a technical solution to a technical problem. As described herein, the technical problem includes computer-compounded human error that results from the current simple computer-based impact assessment methodologies based in manual processes. Such methods rely almost entirely on completing text boxes with human-generated responses that are prone to human error and subjectivity. The present disclosure embraces an improvement over existing solutions by allowing for the improvement in change management and the associated impacts associated therewith (i) with fewer steps to achieve the solution (e.g., implementing a machine learning model to automate the assessment of dependencies, type of impact, etc., in one step), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., by eliminating redundant analysis and unnecessary approvals of proposed changes that would otherwise occur if an improper materiality assessment was performed), (iii) removing manual input and waste from the implementation of the solution, thus improving speed and efficiency of the process and conserving network resources (e.g., eliminating the need to manually determine what entity network systems would be impacted by a change, or manual computation of materiality), (iv) determining an optimal amount of resources that need to be used to implement the solution, thus reducing network traffic and load on existing network resources (e.g., use machine learning algorithms to dynamically route proposed alterations to optimal endpoint devices and/or endpoint device groups for approval, rather than requiring additional re-routing). In other words, the solution may bypass a series of steps previously implemented, thus further conserving network resources. Furthermore, the technical solution described herein uses a rigorous, computerized process to perform specific tasks and/or activities that were not previously performed.

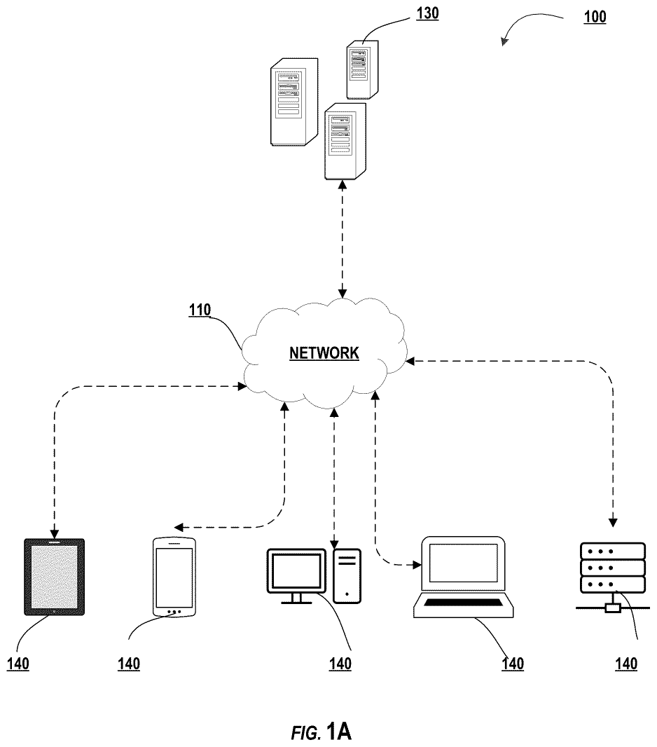

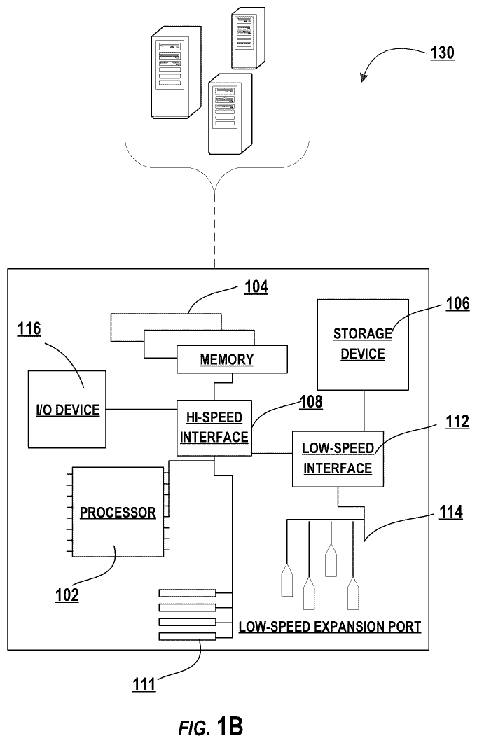

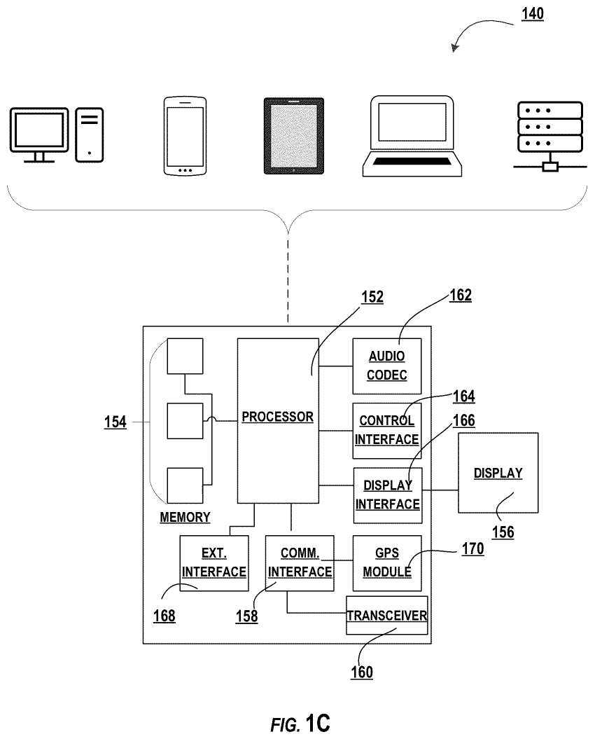

FIGS. 1A-1C illustrate technical components of an exemplary distributed computing environment 100 for reconfiguration authorization protocol and analytics via integrated machine learning, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

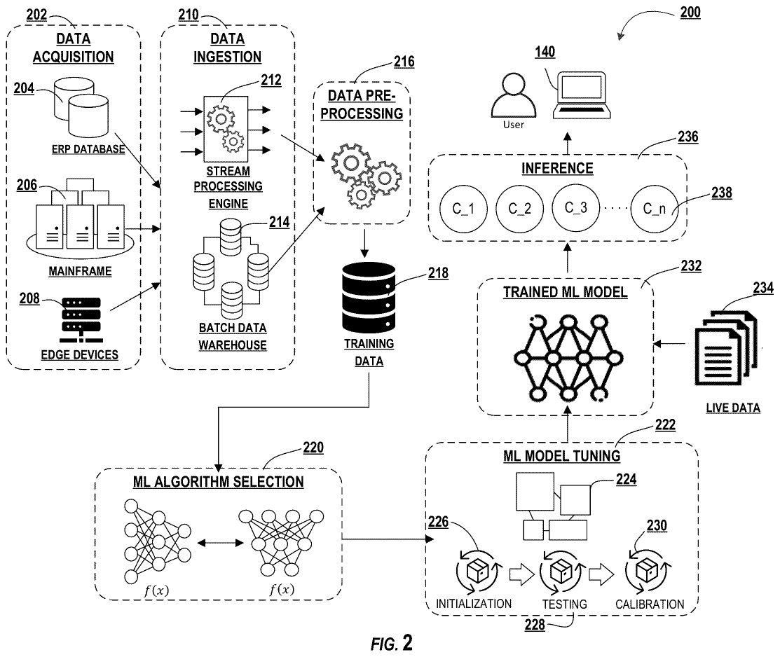

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 216, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

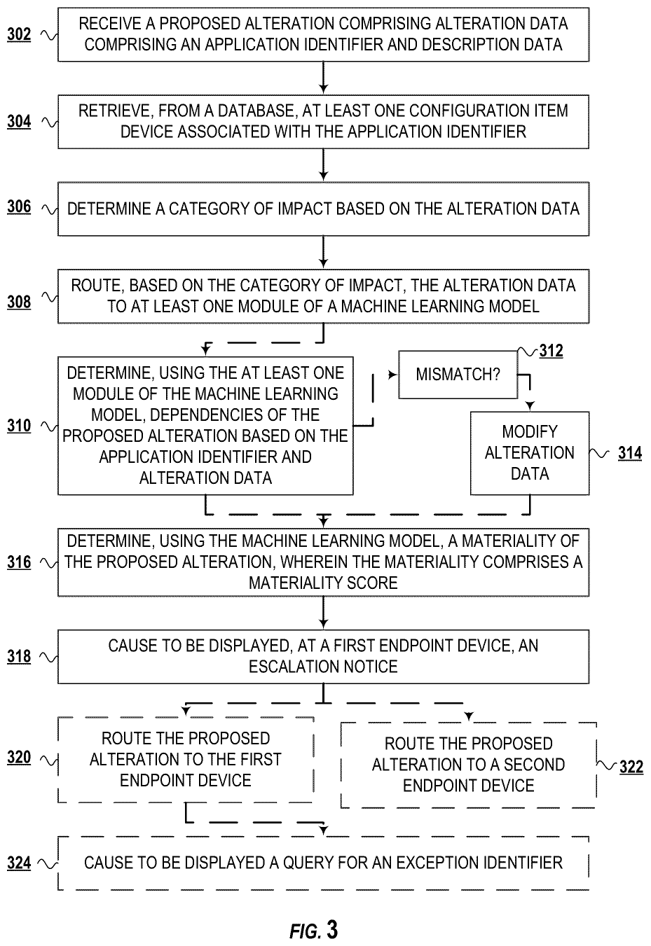

FIG. 3 illustrates a process flow for reconfiguration authorization protocol and analytics via integrated machine learning, in accordance with an implementation of the disclosure. At block 302, the system 130 may receive a proposed alteration. The proposed alteration may be received at an endpoint device 140 of a user, where the endpoint device 140 receives the proposed alteration through the interface of the endpoint device 140.

In some implementations, the proposed alteration may be provided by a repository such as a database, where previously generated proposed alterations may be stored for later evaluation by the system 130 described herein.

For example, in some implementations, regularly recurring alterations such as upgrades and maintenance to entity systems and/or applications may be generated in advance (e.g., days, weeks, years in advance) and may be populated in such databases until a predetermined time interval upon which the regularly recurring alterations is to occur.

Regardless, the proposed alteration, or previously generated proposed alteration (both of which will be referred to herein as a “proposed alteration”), may include alteration data.

In some implementations, the alteration data may include an application identifier. An application identifier may be an identifier assigned to a specific software application, hardware device, or other system resource within the network (any of which will be referred to herein as an “application” having an “application identifier”). The application identifier may include one or more alphanumeric characters used within the entity network to distinguish between different applications, and in doing so track and manage each application.

Additionally, or alternatively, the alteration data may include description data. Description data may be natural language provided as a part of the proposed alteration to describe the purposes of the alteration, the particular types of alterations to be performed, systems that may be impacted, or the like. The description data may be typically provided by a user upon creation of the proposed alteration, and provided through a text box, voice to text, chatbot, or other means by which an endpoint device 140 receives information.

For example, description data for one proposed alteration may be that the proposed alteration is for “updating the application to the new version,” or “backing up the database,” “releasing the new website” or any such activities that generally require change management evaluation prior to implementation. The description data may also indicate the assumed dependencies of the application, such as “updating Application A should only impact Application B.”

Next, at block 304, the system 130 may retrieve at least one configuration item device associated with the application identifier. It shall be appreciated that an entity may keep track of configuration item devices (e.g., hardware, software, documentation) associated with each of the application identifiers. Such configuration item devices may be recorded in a configuration management database. For example, a configuration management database may contain a list of servers providing service to a particular application based on the application identifier. These servers may be considered “configuration item devices” as any changes to the application that utilizes such servers may have an impact on said servers. Similarly, configuration item devices may also include endpoint devices 140 of any type (e.g., computers, laptops, mobile devices, or the like).

In some implementations, the configuration database associated with the application identifier, provided as a part of the proposed alteration that contains the at least one configuration item device, may fully represent the dependencies that could be implicated in a proposed alteration. In other implementations, the configuration database associated with the application identifier provided as a part of the proposed alteration that contains the at least one configuration item device may represent more dependencies than that which could actually implicated in a proposed alteration. In yet additional implementations, the configuration database associated with the application identifier provided as a part of the proposed alteration that contains the at least one configuration item device may represent fewer dependencies than that which could actually implicated in a proposed alteration.

Indeed, as true dependencies vary based on the scope of the proposed alteration, and not just the application identifier itself, the configuration database may be an important tool, but not necessarily fully accurate in terms of impact of a proposed change if taken in isolation. Instead, and as will be discussed further herein, other process steps may provide more clarity with respect to the materiality/impact of the proposed alteration, for example by using the system 130 to determine the scope of the dependencies.

Nonetheless, the configuration item devices identified from the configuration management database may be used in later processes as an input to a machine learning model, as will be described herein.

It shall be appreciated that entities, especially those with broad organizational footprint with many resources such as applications, devices, servers, or the like, across a numerous sectors that require different treatment of impact assessment. Examples include impacts as a result of alterations that involve Compliance and Operational, Reputational, Strategic, Model, Market, Liquidity, and Credit, each of which is a category of impact. As such, at block 306, it may be important to determine a category of impact of the proposed alteration based on the alteration data.

In some implementations, the category of impact may be determined by querying a lookup table with the application identifier, the lookup table having been pre-populated with a list of application identifiers and corresponding categories of impact. Additionally, or alternatively, the category of impact may be determined by providing the application identifier and/or the description data to a machine learning model, the machine learning model having been trained to predict the category of impact based on natural language processing of the description data and/or parsing of portions of the application identifier to infer type of application, date of implementation, etc. Additionally, or alternatively, the category of impact may be provided from a secondary system. In other words, the system 130 herein may not determine the category explicitly, but instead it may receive data regarding the category of impact, and the system 130 may interpret said data.

Next, at block 308, the system 130 may route the alteration data to a machine learning model. The alteration data may be routed to one or more modules of the machine learning model based on the category of impact determined in block 306. Each module may be specific to one category of impact. In doing so, the alteration data is routed to a module suited for the type of impact associate with the alteration data.

Using distinct modules may offer technical advantages over a single large machine learning model. Being specialized to certain categories of impact allows each module to focus on tailored aspects of each impact category and thus improve accuracy. These modules can also operate more efficiently by reducing unnecessary complexity, and they allow for transfer learning or reusability across similar tasks, which further enhances system adaptability and performance.

For example, one module may be specific to compliance and operations. Such a module may be better equipped (i.e., trained) to evaluate proposed alterations that may interfere with regulatory requirements for operational continuity or downtime. Similarly, the module may be better equipped than others to evaluate changes to data handling, storage, or transmission, since data protection regulations may impose certain regulatory requirements.

Next, at block 310, the system 130 may determine dependencies of the proposed alteration. This determination may be accomplished using the one or more modules of the machine learning model, which may receive the application identifier and alteration data and be instructed to determine dependencies therefrom.

The machine learning model may be trained on logs, the system of records (e.g., data regarding previously implemented alterations), network traces, and/or monitoring data that provide records or failure reports, API calls, resource access, or the like. These may provide time-based interactions between systems within the network, which the machine learning model may deduce are related to one another (i.e., have dependencies). By having such information available from training, the application identifier and/or the alteration data may be provided and a list of dependencies of the proposed alteration is output. These dependencies may be combined with those from block 304 (the configuration item devices identified from the configuration management database). In instances where duplicates are determined, duplicates may be removed.

The output of this process may be stored as datasets in data structure form, such as a matrix or adjacency list, hereinafter referred to as a “true dependence matrix”. For example, if Application A is dependent on Applications B and C, a true dependence matrix may indicate B and C as being the dependencies of Application A. While the foregoing example refers to dependencies between applications, it is important to recognize that applications may be dependent on devices, vice versa, which could be dependent on a server, and so forth. Indeed, dependencies between multiple different types of “applications”are contemplated herein.

In some implementations, a proposed alteration may include alteration data (e.g., description data and/or application identifier(s)) that do not align with the dependencies of the application determined by the machine learning model. For example, the description data provided alongside the proposed alteration may purport that the proposed alteration will only affect access to servers on the east coast for a period of 2 hours. However, the machine learning model in the foregoing steps may determine that the west coast servers, in addition to the servers on the east coast, would also be inaccessible for the given time period as a result of taking a particular application off-line. Such a discrepancy illustrates a potential oversight (i.e., “bias”) by the user, or group of users, who created the proposed alteration. By highlighting this oversight, in such ways as providing notifications thereof, further analysis into the previously unknown dependencies can occur, which may ultimately lead to a decision to forego the proposed alteration, change the date or time on which the proposed alteration is to occur, or the like.

Accordingly, and as illustrated in block 312, a presence of a mismatch between the alteration data and the dependencies of the proposed alteration may be determined. In some implementations, the presence of a mismatch (i.e., to determine if bias exists) may be determined based on computer-implemented comparison. Upon receiving the alteration data, a natural language processing engine may receive the alteration data (e.g., the description data) and extract language determined to be a dependence assertion (e.g., description data stating “this change to Application A will only affect Application D”). The natural language processing engine may look for keywords such as “affect” or “impact” and make inferences based on the text surrounding these keywords. The natural language processing engine analyzes the structure and meaning of the provided text to identify relevant patterns and concepts related to the predetermined keywords “affect” or “impact” or the like. It then matches these terms and context with similar or semantically related content within the text to retrieve the relevant information (e.g., what is being affected or impacted).

Thereafter, a dependence assertion may be structured into a data structure form (referred to herein as a “asserted dependence matrix”) for comparison with the true dependence matrix associated with the invoked applications (e.g., by referencing the application identifier). Continuing with the previous example, an asserted dependence matrix may be generated that states that Application A is dependent on Application D. The system then checks whether the asserted dependence matrix matches the true dependence matrix. If identical, the system determines that the assertion is true. If the asserted dependencies in the asserted dependence matrix are a subset of the actual dependencies in the true dependence matrix (e.g., the assertion lists Application B, but the data shows dependencies on both Application B and Application C), the system determines that the assertion is partially false, as it omits some dependencies. Finally, if there is no overlap or if the dependencies listed in the asserted dependence matrix contradicts the true dependence matrix, the system determines that the assertion is false.

A predetermined threshold may be implemented, such that a predetermined number of omitted dependencies and/or extra dependencies is still indicative that the asserted dependencies are true, while anything above the predetermined threshold is indicative that the asserted dependencies are false (i.e., there is a “mismatch”).

If a mismatch is determined to exist, the alteration data (i.e., the data that led to the asserted dependencies) may be modified at block 314 with the true dependencies of the proposed alteration (i.e., the true dependencies from the true dependency matrix). In this way, further analysis, viewing, implementation, or the like, of the proposed alteration reflects the true impact of the proposed alteration.

Notwithstanding the presence of any mismatch, the system 130 at block 316 may determine, a materiality of the proposed alteration using the machine learning model. The materiality may be expressed as a materiality score on a predetermined scale, for example 1 to 10, 1 to 100, and so forth, with one end of the predetermined scale representing a proposed alteration with less impact (e.g., very few dependencies, short duration of the proposed alteration), and the other end of the predetermined scale representing a proposed alteration with more impact (e.g., many dependencies, long duration of the proposed alteration).

The materiality score based on at least one of the application identifiers, description data (e.g., based on natural language used in the description data), or the like. As used herein, the materiality score refers to a numerical score, a letter score, a ranking, and/or the like that indicates how likely or unlikely the proposed alteration is to meet the acceptable level of entity impact as a result of an implemented proposed alteration, and/or the like. Therefore, the materiality score(s) may be used to identify how likely or unlikely proposed alteration is to meet acceptable level of entity impact as a result of an implemented proposed alteration, and/or the like. The kind of likelihood (e.g., a likelihood or unlikelihood) may be predetermined before the materiality score is generated and used by the trained machine learning model to generate the materiality score. In some implementations, the materiality score may comprise a low score to indicate an unlikelihood for entity impact (e.g., disruption in services) and/or a high score to indicate a highly likely and widespread entity impact.

In some implementations, the machine learning model may be trained using a system of records. The system of records, providing a historical archive of alterations implemented in the past, may provide data regarding the time it took to implement alterations related to certain applications. These times may then be taken into consideration upon determining the materiality score. The system of records may also provide data regarding the materiality scores determined in the alterations implemented in the past, such as to improve the determining of the materiality score using materiality scores previously applied. It shall be appreciated that the system of records also identifies the applications, the correlations between applications, time required for implementing alterations, materiality scores, dependencies, etc., and may be labeled and used as training datasets.

In some implementations, the machine learning model may be trained via online machine learning in conjunction with a stream of impact data from a third-party impact database. It shall be appreciated that some applications may undergo alterations (e.g., software updates) that imposes a new impact, the scope of which is controlled by a third-party (e.g., the supplier of the application), and the proposed alteration is simply to implement the alterations (e.g., software update) across the entity network. However, since the scope of the alterations is controlled by a third-party, such third-parties may provide a stream of impact data to the system 130 herein to alter materiality assessments (e.g., materiality scores) accordingly, should the proposed alteration use an application identifier corresponding to the third-party.

One or more third parties may provide a hook or API to receive this impact data. In some implementations, the impact data may take the form of a modifier command, such that any proposed alteration using an application associated with the third-party impact database should increase or decrease the materiality score by a predetermined amount. Additionally, or alternatively, the impact data may include dependencies (e.g., the stream of impact data may indicate changes to the number of, or identity of, dependencies of the application, for a given alteration). Additionally, or alternatively, the impact data may include implementation time (e.g., the stream of impact data may indicate a long duration of implementing an alteration).

To implement online machine learning, the stream of impact data received may be processed individually or in small batches, and adjust model parameters in real-time or near real-time using algorithms such as stochastic gradient descent (SGD) or incremental variants of other optimization methods. In this way, the machine learning model may take into consideration, via continuous training, new information, and output a materiality score accordingly.

In some implementations, the proposed alteration may be prioritized in a queue based on the materiality score prior to being implemented. It shall be appreciated that it may be beneficial for a user associated with the entity to view, on a dashboard, a list of proposed alterations analyzed by the system 130, such that a prioritization of the implementation of said proposed alterations may be performed. In this way, for example, the entity can implement alterations with high materiality scores (i.e., alterations that are more disruptive or impactful) during prescribed times to reduce network activity impact to the entity. Similarly, such a dashboard may allow for entities to implement alterations with low materiality scores during times with less potential for loss of network activity.

At block 318, the system 130 may cause to be displayed, on a first endpoint device, an escalation notice. This escalation notice may be a popup or banner on a dashboard or the like, indicating that the proposed alteration needs additional approvals from other users or systems, since the impact is high. This determination may be made based on a predetermined threshold, such that a materiality score above the threshold, for example, indicates the need for escalation (i.e., additional approval), while a materiality score of the proposed alteration below the threshold may be allowed to be implemented without such escalation.

In some implementations, the first endpoint device may be the endpoint device on which the proposed alteration was received. In other implementations, the first endpoint device may be a different endpoint device than that on which the proposed alteration was received.

In some implementations, the system 130 may generate an approval request and transmit it to a second endpoint device associated with the required escalation (e.g., the endpoint device on which approval must be given). As such, the process may continue at block 322 where the proposed alteration is routed to the second endpoint device upon a condition where the materiality score may be above the predetermined threshold.

For example, all escalations may need to be routed to a specific endpoint device, and upon determining the materiality score being above the predetermined threshold, a notification containing a request for approval, and the proposed alteration (e.g., the alteration data), may be transmitted to the second endpoint device. Upon receiving an interaction with an interaction element on the notification at the specified endpoint device, the proposed alteration may be implemented.

Alternatively, at block 320, the system 130 may route the proposed alteration to a different endpoint device, or the first endpoint device, upon a condition where the materiality score may be below the predetermined threshold.

In some implementations, and as illustrated at block 324, upon a condition where the materiality score is above the predetermined threshold, the system 130 may cause to be displayed, at either the first or the second endpoint device, a query for an exception identifier.

An exception identifier may be an alphanumeric or other character-based code that is provided to individuals to override an “exception.” One exception may be that the proposed alteration has a materiality score above the predetermined threshold. Other exceptions include if the proposed alteration identifies, via the application identifier, an application of a predetermined group that requires the use of the exception identifier. By providing exception identifiers to certain endpoint devices or users with supervisory or management positions, these exception identifiers act as keys to only allow for the implementation of a proposed alteration by designated persons, endpoint device, etc.

As such, in some implementations, either prior to being implemented, and/or after the determination of the materiality score of the proposed alteration, a request or query for receiving an exception identifier may be caused to be shown on the first or the second endpoint device.

Upon the exception identifier being provided at the predetermined endpoint device, the system 130 may compare the exception identifier to that which is maintained by the system 130 in an exception identifier database. The exception identifier database may correspond certain exception identifiers with predetermined groups of materiality scores and/or application identifiers. In this way, very high materiality scores (e.g., materiality scores above a first and a second predetermined threshold) may require one exception identifier, while high (but still above the first predetermined threshold) may require a different exception identifier or multiple exception identifiers.

If the comparison results in a match, the proposed alteration may be implemented, or in some implementations queued for implementation.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for reconfiguration authorization protocol and analytics via integrated machine learning, the system comprising:
a processing device; and
a non-transitory storage device containing instructions, when executed by the processing device, the instructions cause the processing device to perform the steps of:
receiving a proposed alteration comprising alteration data comprising an application identifier and description data;
retrieving, from a database, at least one configuration item device associated with the application identifier;
determining a category of impact based on the alteration data;
routing, based on the category of impact, the alteration data to at least one module of a machine learning model, wherein the at least one module is specific to the category of impact;
determining, using the at least one module of the machine learning model, dependencies of the proposed alteration based on the application identifier and alteration data;
determining, using the machine learning model, a materiality of the proposed alteration, wherein the materiality comprises a materiality score; and
causing to be displayed, at a first endpoint device, an escalation notice, upon a first condition where the materiality score is above a predetermined threshold.

2. The system of claim 1, wherein the instructions further cause the processing device to perform the steps of:
routing the proposed alteration to the first endpoint device upon the first condition where the materiality score is above the predetermined threshold, and
routing the proposed alteration to a second endpoint device upon a second condition where the materiality score is below the predetermined threshold.

3. The system of claim 2, wherein the instructions further cause the processing device to perform the steps of:
causing to be displayed, at the first endpoint device, a query for an exception identifier, upon the first condition where the materiality score is above the predetermined threshold.

4. The system of claim 1, wherein the machine learning model is trained using a system of records.

5. The system of claim 1, wherein the machine learning model is trained via online machine learning in conjunction with a stream of impact data from a third-party impact database.

6. The system of claim 1, wherein the proposed alteration is prioritized in a queue based on the materiality score.

7. The system of claim 1, wherein the instructions further cause the processing device to perform the steps of:
determining, based on the dependencies of the proposed alteration, a presence of a mismatch between the alteration data and the dependencies of the proposed alteration; and
modifying the alteration data with the dependencies of the proposed alteration, upon a third condition where the mismatch is present.

8. A computer program product for reconfiguration authorization protocol and analytics via integrated machine learning, the computer program product comprising a non-transitory computer-readable medium comprising code causing an apparatus to:
receive a proposed alteration comprising alteration data comprising an application identifier and description data;
retrieve, from a database, at least one configuration item device associated with the application identifier;
determine a category of impact based on the alteration data;
route, based on the category of impact, the alteration data to at least one module of a machine learning model, wherein the at least one module is specific to the category of impact;
determine, using the at least one module of the machine learning model, dependencies of the proposed alteration based on the application identifier and alteration data;
determine, using the machine learning model, a materiality of the proposed alteration, wherein the materiality comprises a materiality score; and
cause to be displayed, at a first endpoint device, an escalation notice, upon a first condition where the materiality score is above a predetermined threshold.

9. The computer program product of claim 8, wherein the code further causes the apparatus to:
route the proposed alteration to the first endpoint device upon the first condition where the materiality score is above the predetermined threshold, and
route the proposed alteration to a second endpoint device upon a second condition where the materiality score is below the predetermined threshold.

10. The computer program product of claim 9, wherein the code further causes the apparatus to:
cause to be displayed, at the first endpoint device, a query for an exception identifier, upon the first condition where the materiality score is above the predetermined threshold.

11. The computer program product of claim 8, wherein the machine learning model is trained using a system of records.

12. The computer program product of claim 8, wherein the machine learning model is trained via online machine learning in conjunction with a stream of impact data from a third-party impact database.

13. The computer program product of claim 8, wherein the proposed alteration is prioritized in a queue based on the materiality score.

14. The computer program product of claim 8, wherein the code further causes the apparatus to:
determine, based on the dependencies of the proposed alteration, a presence of a mismatch between the alteration data and the dependencies of the proposed alteration; and
modify the alteration data with the dependencies of the proposed alteration, upon a third condition where the mismatch is present.

15. A method for reconfiguration authorization protocol and analytics via integrated machine learning, the method comprising:
receiving a proposed alteration comprising alteration data comprising an application identifier and description data;
retrieving, from a database, at least one configuration item device associated with the application identifier;
determining a category of impact based on the alteration data;
routing, based on the category of impact, the alteration data to at least one module of a machine learning model, wherein the at least one module is specific to the category of impact;
determining, using the at least one module of the machine learning model, dependencies of the proposed alteration based on the application identifier and alteration data;
determining, using the machine learning model, a materiality of the proposed alteration, wherein the materiality comprises a materiality score; and
causing to be displayed, at a first endpoint device, an escalation notice, upon a first condition where the materiality score is above a predetermined threshold.

16. The method of claim 15, the method further comprising:
routing the proposed alteration to the first endpoint device upon the first condition where the materiality score is above the predetermined threshold, and
routing the proposed alteration to a second endpoint device upon a second condition where the materiality score is below the predetermined threshold.

17. The method of claim 16, the method further comprising:
causing to be displayed, at the first endpoint device, a query for an exception identifier, upon the first condition where the materiality score is above the predetermined threshold.

18. The method of claim 15, wherein the machine learning model is trained using a system of records.

19. The method of claim 15, wherein the machine learning model is trained via online machine learning in conjunction with a stream of impact data from a third-party impact database.

20. The method of claim 15, wherein the proposed alteration is prioritized in a queue based on the materiality score.
